(19) United States
(12) Patent Application Publication
(10) Pub. No.: US 2009/0094900 A1
(43) Pub. Date: Apr. 16, 2009

(54) METHOD OF FORMING A POLYUREA POLYURETHANE ELASTOMER CONTAINING CHEMICAL MECHANICAL POLISHING PAD

(75) Inventors: Robert G. Swisher, Pittsburgh, PA (US); William C. Allison, Murrysville, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/194,700

(22) Filed: Aug. 20, 2008

Related U.S. Application Data
(60) Provisional application No. 60/979,992, filed on Oct. 15, 2007.

(51) Int. Cl. C09K 3/14

(52) U.S. Cl. 51/298; 264/240

(57) ABSTRACT

A method of forming a chemical mechanical polishing pad includes providing a first reactant including an isocyanate functional polyurethane prepolymer at a temperature above about 60° C., providing a second reactant including a diamine at a temperature above about 100° C., impingement mixing the first reactant and the second reactant within an impingement mixer to begin formation of a polyurea polyurethane elastomer, wherein the mixing is at a ratio of the first reactant to the second reactant of about 3:1 to about 6:1, casting the polyurea polyurethane elastomer that is formed from the mixed first and second reactants; and forming the polyurea polyurethane elastomer into chemical mechanical polishing pad dimensions. The polyurea polyurethane elastomer may further be provided with surface grooves and can be used as a single layer pad or formed into various stacked pad arrangements.

### CROSS-REFERENCE TO RELATED APPLICATION

This application claims the benefit of priority of U.S. Provisional Application No. 60/979,992, filed Oct. 15, 2007.

### BACKGROUND OF THE INVENTION

1. Field of the Invention

The present invention relates to methods of forming chemical mechanical polishing (CMP) pads, and more particularly the present invention relates to methods of forming polyurea polyurethane elastomer containing CMP pads using impingement mixing.

2. Background Information

Chemical-mechanical planarization or Chemical-mechanical polishing, commonly abbreviated CMP is a technique used in semiconductor fabrication for planarizing the top surface of an in-process semiconductor wafer or other substrate. The process typically uses an abrasive and a reactive chemical slurry, commonly a colloid, (collectively called the polishing fluid) in conjunction with a polishing pad and retaining ring, typically of a greater diameter than the wafer. The pad and wafer are pressed together by a dynamic polishing head and the wafer is held in place by the retaining ring. The dynamic polishing head and pad are rotated, with different axes of rotation (i.e., not concentric) to remove material and to even out irregular topography, making the wafer flat or planar. This is generally necessary in order to set up the wafer for the formation of additional circuit elements. For example, this might be necessary in order to bring the entire surface within the depth of field of a photolithography system, or to selectively remove material based on its position. Typical depth-of-field requirements are at nanometer levels. Other systems using polishing belts have also been proposed, but rotary polishing or orbital polishing systems are more common in the industry.

A polishing pad for a rotary CMP polishing apparatus is a relatively thin, planar, disk-shaped article. The pad typically includes at least a polishing layer having a polishing surface on a first end of the polishing pad and a polishing layer peripheral edge extending away from the polishing surface. If only the polishing layer is present the pad is known as a single layer pad. The pad may be formed of multiple layers which is sometimes referred to as a stacked pad construction. Examples of single layer and stacked pads are commercially available from the PPG Industries and Rohm & Haas Electronic Materials (R&H).

The CMP polishing pad must be placed on a platen of a polishing machine, or on another mounting surface (herein collectively called platens), and secured to the platen by a pressure sensitive adhesive on the back surface of an attaching layer on the polishing pad. The attaching layer typically is a gas impermeable layer such as a PET type layer. Examples of attaching layers are sold by 3M, Inc. Adhesives Research, Inc. and Adchem, Inc.

At least in the polishing layer of a polishing pad it is common to have pores or cells dispersed throughout the layer. It is well established that cell size control is an important characteristic for most, if not all, CMP pads. A CMP pad material, and process for manufacturing such a CMP pad, which provides for more uniform cell size and/or smaller cell size, and which does not require incorporation of a foreign material, has been identified as being particularly desirable.

Known in the art are CMP pads formed from a polyurethane-based foam having a desired shape obtained by a process which comprises mixing a polyurethane or polyurea as a main raw material with various subsidiary raw materials, dissolving an inert gas in the mixture under pressure to obtain a gas-dissolved raw material, and then injecting the gas-dissolved raw material into a mold by a reaction injection molding (RIM) method. The polyurethane-based foam obtained by the reaction in the injection mold has fine and uniform cells suitable for polishing of semiconductor material or the like.

Also known is a CMP pad prepared by a method utilizing shear forces to control the cell size. Such a polishing pad is formed by a reaction injection molding (RIM) method where gas is mixed with a polymeric resin component prior to adding an isocyanate component. A polishing pad having uniform microcellular size can be produced by introducing a gas into a polymeric resin contained in a pressurized tank, pumping the polymeric resin and gas mixture through a fine porosity stone mixer, mixing the polymeric resin and gas mixture with an isocyanate to form a resulting mixture, and injecting the resulting mixture into a mold. Also, the gas can be introduced into the polymeric resin through a sparging tube. Alternatively the polymeric resin and gas mixture may be passed through an emulsifier and/or a homogenizing mixer after being pumped through the fine stone porosity mixer. Further, the polymeric resin and gas mixture can be forced through a high shear cavitation device which effects shear forces to cause the material to vaporize.

Generally, polyurethane reaction injection molding (RIM) technology was developed in the late 1960s by Bayer AG. The universal physical characteristics of polyurethane RIM parts are high strength and low weight. Like thermoplastic injection molding, RIM is a plastics-forming process that employs molds to form parts. As its name implies, the polyurethane RIM process uses polyurethanes to produce molded parts. The polyurethanes begin as two liquid components, as compared with the pellet form of most thermoplastics. These liquid components—an isocyanate and a polyol—are combined in two-part formulations, which are often called polyurethane RIM systems. In general, depending on how the polyurethane RIM system is formulated, the resulting parts can be in the form of a foam or a solid, and they can vary from flexible to extremely rigid. Part density also can vary widely with specific gravities ranging from 0.2 to 1.6 g/cc.

The polyurethane RIM process is based upon a chemical reaction between the two liquid components, which typically are held in separate, temperature-controlled feed tanks equipped with agitators. From these tanks, the isocyanate and polyol feed through supply lines to metering units that precisely meter both components, at high pressure, to an impingement mixer, also called a mixhead device. The liquid reactants enter a chamber in the impingement mixer at high pressures, such as between 1,500 and 3,000 psi, where they are intensively mixed by high-velocity impingement. From the mix chamber, the liquid then flows into the mold. Inside the mold, the liquid undergoes an exothermic chemical reaction, which forms the polyurethane polymer in the mold. Shot (or fill) and cycle times vary, depending on the part size and the polyurethane system used in RIM. An average mold for an elastomeric part may be filled in one second or less and be ready for demolding in 30-60 seconds.

### SUMMARY OF THE INVENTION

It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The various embodiments and examples of the present invention as presented herein are understood to be illustrative of the present invention and not restrictive thereof and are non-limiting with respect to the scope of the invention.

The present invention is directed to a method of forming a chemical mechanical polishing pad. The method comprises providing a first reactant including an isocyanate functional polyurethane prepolymer at a temperature above 60° C., providing a second reactant including a diamine at a temperature above 100° C., impingement mixing the first reactant and the second reactant within an impingement mixer to begin formation of a polyurea polyurethane elastomer, wherein the mixing is at a ratio of the first reactant to the second reactant of 3:1 to 6:1 by weight, casting the polyurea polyurethane elastomer that is formed from the mixed first and second reactants; and forming the polyurea polyurethane elastomer into chemical mechanical polishing pad dimensions. The polyurea polyurethane elastomer may further be provided with surface grooves and can be used as a single layer pad or formed into various stacked pad arrangements.

According to one embodiment, the present invention is directed to a method of forming a chemical mechanical polishing pad comprising providing a first reactant including an isocyanate functional polyurethane prepolymer and a second reactant including a diamine impingement mixing the first reactant and the second reactant within an impingement mixer to begin formation of a polyurea polyurethane elastomer, injection molding the polyurea polyurethane elastomer that is formed from the mixed first and second reactants in a closed mold, demolding the polyurea polyurethane elastomer from the mold; curing the demolded polyurea polyurethane elastomer; and forming the demolded polyurea polyurethane elastomer into chemical mechanical polishing pad dimensions. As noted above, the polyurea polyurethane elastomer may further be provided with surface grooves and can be used as a single layer pad or formed into various stacked pad arrangements.

Also, the present invention is directed to a method of forming a chemical mechanical polishing pad comprising providing a first reactant including an isocyanate functional polyurethane prepolymer and a second reactant including a diamine, impingement mixing the first reactant and the second reactant within an impingement mixer to begin formation of a polyurea polyurethane elastomer, open casting the polyurea polyurethane elastomer that is formed from the mixed first and second reactants; and forming the polyurea polyurethane elastomer into chemical mechanical polishing pad dimensions. The polyurea polyurethane elastomer may further be provided with surface grooves and can be used as a single layer pad or formed into various stacked pad arrangements.

These and other advantages of the present invention will be clarified in the description of the preferred embodiments taken together with the attached figures.

### BRIEF DESCRIPTION OF THE DRAWINGS

FIG. 1 schematically illustrates the apparatus and process for forming polyurea polyurethane elastomer containing CMP pads using impingement mixing and injection molding into a closed mold according to one embodiment of the present invention;

FIG. 2 schematically illustrates the apparatus and process for forming polyurea polyurethane elastomer containing CMP pads using impingement mixing and injection molding into a closed mold according to another embodiment of the present invention;

FIG. 3 schematically illustrates the apparatus and process for forming polyurea polyurethane elastomer containing CMP pads using impingement mixing and open casting according to one embodiment of the present invention;

FIG. 4 schematically illustrates the apparatus and process for forming polyurea polyurethane elastomer containing CMP pads using impingement mixing and open casting according to another embodiment of the present invention; and

FIG. 5 schematically illustrates polyurea polyurethane elastomer containing CMP stacked pad formed according to one embodiment of the present invention.

### DESCRIPTION OF THE PREFERRED EMBODIMENTS

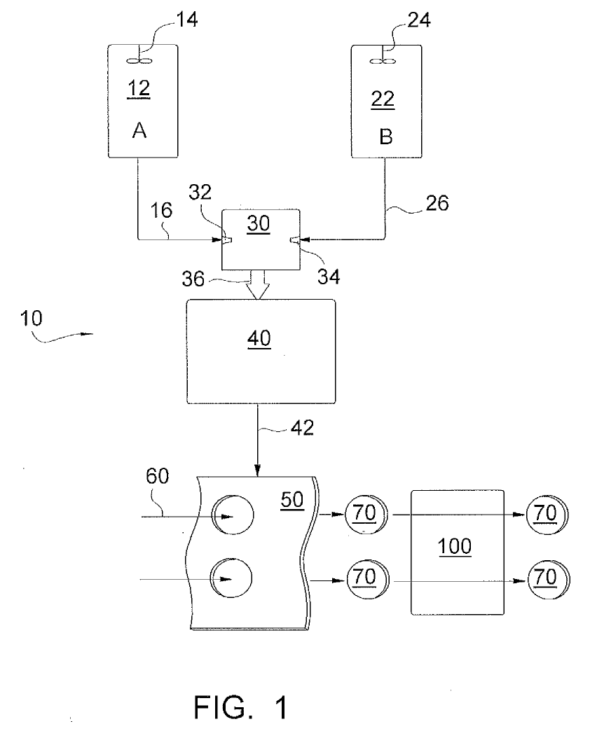

FIG. 1 schematically illustrates the apparatus 10, and the associated process, for forming polyurea polyurethane elastomer containing CMP pads 70 using impingement mixing and injection molding into a closed mold 40 according to one embodiment of the present invention. Tank 12 with agitator 14 allows for the provision of a first reactant, also called part A, including an isocyanate functional polyurethane prepolymer.

The isocyanate functional polyurethane prepolymer can be a reaction product of any of a variety of art-recognized polyisocyanates and any of a variety of art-recognized polyols. For example, at least one polyol such as but not limited to a diol, and at least one isocyanate functional monomer such as but not limited to a diisocyanate monomer, can be reacted together to form a polyurethane prepolymer having at least two isocyanate groups. Non-limiting examples of suitable isocyanate functional monomers include but are not limited to α,α′-xylene diisocyanate, α,α,α′,α′-tetramethylxylene diisocyanate, isophoronediisocyanate, bis(isocyanatocyclohexyl)methane, toluene diisocyanate, 4,4′-diphenylmethane diisocyanate and mixtures thereof.

Many suitable polyols of various types and molecular weight are commercially available from various manufacturers. Non-limiting examples of suitable polyether polyols can include but are not limited to polyoxyalkylene polyols, and polyalkoxylated polyols prepared by condensing an alkylene oxide, or a mixture of alkylene oxides. Non-limiting examples of alkylene oxides can include ethylene oxide, propylene oxide, butylene oxide, amylene oxide, mixtures of ethylene oxide and propylene oxide. Further, polyoxyalkylene polyols can be prepared with mixtures of alkylene oxide using random or step-wise oxyalkylation. Non-limiting examples of such polyoxyalkylene polyols can include polyoxyethylene, but are not limited to polyethylene glycol, polyoxypropylene, such as but not limited to polypropylene glycol. The term “polyol” can include the generally known poly(oxytetramethylene) diols prepared by the polymerization of tetrahydrofuran in the presence of Lewis acid catalysts such as but not limited to boron trifluoride, tin (IV) chloride and sulfonyl chloride. Suitable polyether polyols also can include TERATHANE™ polyether glycol which is commercially available from DuPont. Also included are the polyethers prepared by the copolymerization of cyclic ethers such as but not limited to ethylene oxide, propylene oxide, trimethylene oxide, and tetrahydrofuran with aliphatic diols such as but not limited to ethylene glycol, 1,3-butanediol, 1,4-butanediol, diethylene glycol, dipropylene glycol, 1,2-propylene glycol and 1,3-propylene glycol. In a non-limiting embodiment, the isocyanate functional polyurethane prepolymer can be prepared by reacting a diisocyanate such as but not limited to toluene diisocyanate, with a polyalkylene glycol such as but not limited to poly(tetrahydrofuran).

The isocyanate functional polyurethane prepolymer typically has an isocyanate content of less than 15% by weight, such as between 2 to 12% by weight, or between about 4 to to 10% by weight. One suitable isocyanate functional polyurethane prepolymer is commercially available from Chemtura under the Adiprene L-325™ tradename. The tank 12 can be maintained at a temperature of greater than 60° C., such as 80° C. The pressure of the tank 12 can range generally from ambient pressure up to 100 PSIG.

In the methods of the present invention an inert gas can be dispersed into the first reactant, which will include dissolution of some or all of the inert gas depending upon the conditions of the tank 12. The metering and effective amounts of the inert gas will be dependent upon the desired final density of the CMP pad layer to be formed. The inert gas can include, for example, CO₂, N₂, Ar, HFCs, and combinations thereof. “Dry air” could also be used, but it should have no moisture content. For example the dry air could include a O₂—N₂ mixture at 21% O₂ concentration. Nitrogen is likely the most cost effective inert gas to be utilized. Tank 22 with agitator 24 allows for the provision of a second reactant(also called part B), including diamine. The diamine may comprise an aromatic diamine chain extender and may have a molecular weight, generally less than 400 g/mol. Suitable diamines can include, for example, 4,4-methylenebis (3-chloro-2,6-diethylaniline), (Lonzacure.™. M-CDEA), which is available in the United States from Air Products and Chemical, Inc. (Allentown, Pa.); 2,4-diamino-3,5-diethyl-toluene, 2,6-diamino-3,5-diethyl-toluene and mixtures thereof (collectively “diethyltoluenediamine” or “DETDA”), commercially available from Albemarie Corporation under the trade name ETHACURE 100; dimethylthiotoluenediamine (DMTDA), which is commercially available from Albemarle Corporation under the trade name ETHACURE 300; 4,4′-methylene-bis-(2-chloroaniline) which is commercially available from Chemtura under the trade name VIBRACURE A133; and combinations of any of the foregoing.

The temperature of the diamine tank, i.e., typically is maintained at least above 100° C., such as 120° C. Tank 22 will generally have the same operational pressure ranges as tank 12, but may not be operating at the same pressure as tank 12.

As noted above, the present invention provides that an inert gas can be dispersed into the first reactant. As an alternative, the described inert gas can be dispersed into Part B in tank 22. The dispersal of the inert gas into part B may be in addition to or in place of the dissolving of the inert gas into part A.

The tank 12 includes an outlet 16 leading to one or more nozzles 32 of an impingement mixer 30 whereby the first reactant can be directed to the mixer 30 for impingement mixing with the second reactant. In a similar fashion, tank 22 includes an outlet 26 leading to one or more opposing nozzles 34 of the impingement mixer 30 whereby the second reactant can be directed to the mixer 30 for impingement mixing with the first reactant. The impingement mixing of the first reactant and the second reactant within the impingement mixer 30 begins formation of a polyurea polyurethane elastomer. Impingement mixing within the meaning of this application means mixing the reactants at high pressures and velocities from intersecting streams as is customary in conventional impingement mixers. Suitable impingement mixers or mixheads are available from Gusmer-Decker; Osborne Industries, Linden Industries, Elastogran Machinery and Cannon. See also U.S. Pat. Nos. 4,053,283, 4,175,874, 4,440,500, 4,592,675, 4,600,312, 4,721,602, 4,772,129, 4,802,770, 4,876,071 and 7,093,972 which disclose various impingement mixers designs.

In the impingement mixing of the first reactant and the second reactant within an impingement mixer 30, the weight ratio of the first reactant to the second reactant ranges from 3:1 to 6:1, such as from 4:1 to 5:1, or from 4:1. This weight ratio will result in an approximate 1 to 1 molar ratio of the reactants, which results in effective polymer formation. The ratio of the first reactant to the second reactant can be accommodated in the mixer 30 by way of varying the inlet orifice of the respective nozzles 32 and 34. Alternatively, the number of inlet nozzles can be increased to accommodate the desired ratio. Finally combinations of these methods may be utilized to obtain the desired ratios. The pressures of the nozzles 32 and 34 operate in conventional ranges for RIM mixers.

The outlet 36 of the mixer 30 in the initial embodiment leads to a closed mold 40. The closed mold 40 would be a conventional mold type for RIM molding, whereby immediately following the mixing step is the step of injection molding of the polyurea polyurethane elastomer (formed from the mixed first and second reactants) in the closed mold 40. The injection molding of the polyurea polyurethane elastomer 50 typically is performed above 80° C. Further the demolding, shown as step 42, of the polyurea polyurethane elastomer 50 occurs at greater than 5 minutes after filling the mold 40. Generally the demold time depends on when the molded component has developed sufficient strength to be demolded without damage, typically a period ranging from 10 to 60 minutes.

In the process of the present invention as shown in FIG. 1, a secondary curing of the demolded polyurea polyurethane elastomer occurs, followed by forming of the demolded polyurea polyurethane elastomer into chemical mechanical polishing pad dimensions. These steps can be performed in any order. As illustrated, the demolded polyurea polyurethane elastomer 50 is formed into chemical mechanical polishing pad dimensions 70 such as by punching or die cutting 60. Obviously the dies 60 would be positioned to minimize the waste from the molded polyurea polyurethane elastomer 50. Following the forming of the pad components 70, the components 70 are given a secondary curing step of about 16-48 hours in a curing oven 100 at about a temperature ranging from 100-130° C. The present invention also anticipates the process of curing the molded polyurea polyurethane elastomer 50 in a secondary cure oven 100 and then forming the components 70, for example, with punches or die cutters 60. The sequence will depend largely upon whether the pad components 70 can be formed at step 60 without damage. The sequence as shown in FIG. 1 offers some space savings, or increased batch size, for the secondary curing oven 100.

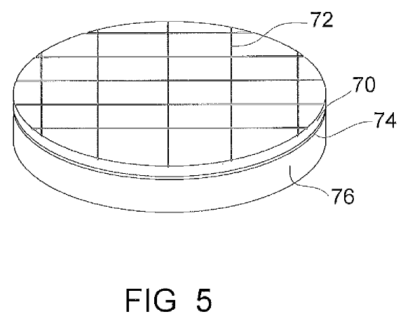

The polyurea polyurethane elastomer component 70, following the secondary cure at 100, may further include surfacing, such as by conventional abrading, and may further be provided with surface grooves 72. The component 70 can be used as a single layer pad or formed into various stacked pad arrangements such as the arrangement shown in FIG. 5. FIG. 5 is a three layer stacked pad having a polishing layer 70 with surface grooves 72, an intermediate barrier layer 74 and a sub-pad layer 76. The single, double and three level pad constructions are known in the art. Further modifications may be added to the resulting pad, such as a metrology window and the like. The polishing layer 70 can have a bulk density ranging from 0.5 to 1.0 g/cc and can contain uniform cells with an average cell diameter ranging from 1 to 75 microns.

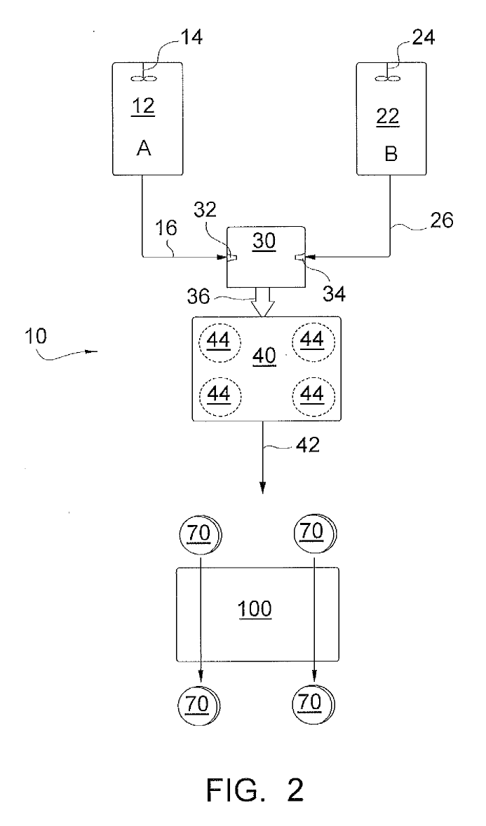

FIG. 2 schematically illustrates the apparatus and process for forming polyurea polyurethane elastomer containing CMP pads using impingement mixing and injection molding into a closed mold 40 according to another embodiment of the present invention. The process and apparatus of FIG. 2 is similar to that of FIG. 1 except that the closed mold 40 includes cavities 44 sized to chemical mechanical polishing pad dimensions. In this schematic arrangement the step of forming the demolded polyurea polyurethane elastomer into chemical mechanical polishing pad dimensions is performed simultaneously with the molding within the mold 40 by the mold cavities 44 themselves. There is no separate punch or die 60 required. Following demolding at step 42 the components 70 can move through a curing oven 100 for the designated curing step as described above.

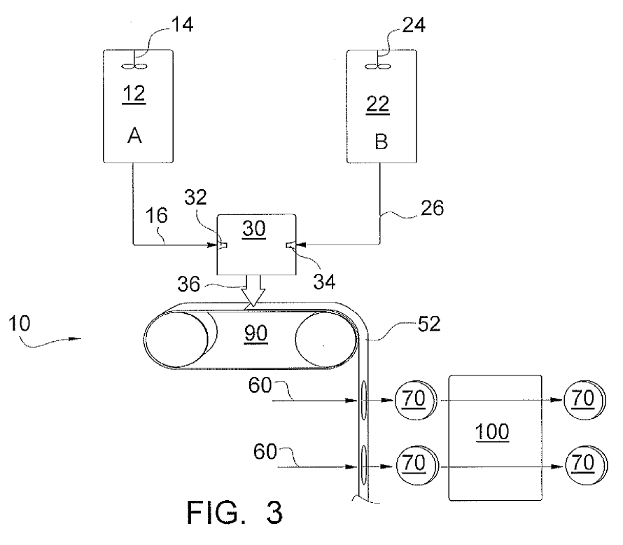

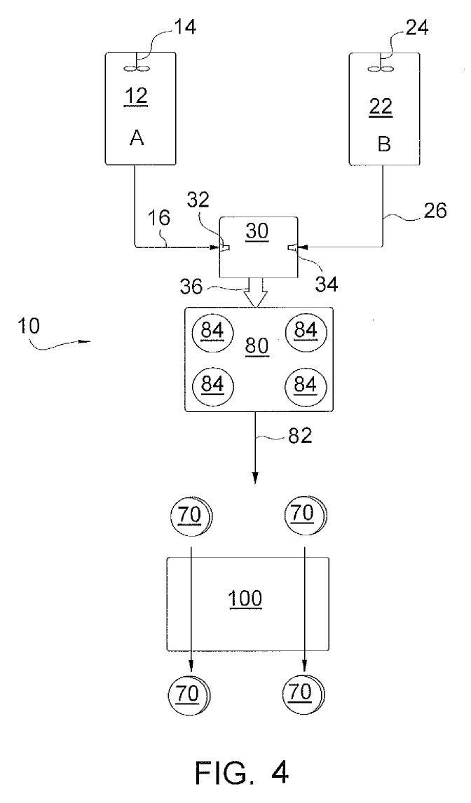

The closed molds 40 of FIGS. 1 and 2 are relatively conventional following the impingement mixer 30 and can be classified as “closed casting”. The present invention however can operate with open casting techniques such as shown in FIGS. 3 and 4. FIG. 3 schematically illustrates the apparatus and process for forming polyurea polyurethane elastomer-containing CMP pads using impingement mixing which is similar to that of FIGS. 1 and 2 except that the closed mold 40 is replaced with an open mold. Open mold techniques can include methods such as casting onto a conveyor 90 with sidewalls (or through a trumpet mold) that can form a continuous molded polyurea polyurethane elastomer 52. The elastomer 52 is the same as elastomer 50 other than elastomer 52 is a continuous sheet. The punch or die formation at 60 would be after the initial cure when the material has sufficient strength for the formation operation. An alternative to this operation is to use a curing oven 100 before formation at step 60, whereby the initial cure and the secondary cure are performed together (as there is no separate “demolding” step in this configuration). FIG. 4 schematically illustrates the apparatus and process for forming polyurea polyurethane elastomer containing CMP pads using impingement mixing which is similar to that of FIGS. 1 and 2 except that the closed mold 40 is replaced with an open mold 80 having mold cavities 84. As with the embodiment illustrated in FIG. 2, in this schematic arrangement the step of forming the demolded polyurea polyurethane elastomer into chemical mechanical polishing pad dimensions is performed simultaneously with the molding within the open mold 80 by the open mold cavities 84 themselves. There is no separate punch or die 60 required. Following demolding at step 82 the components 70 can move through a curing oven 100 for the designated curing step as described above.

Whereas a particular embodiment of this invention has been described above for purposes of illustration, it will be evident to those skilled in the art that numerous variations of the details of the present invention may be made without departing from the invention as defined in the appended claims. For example, first and/or second reactants may include surfactants, fillers, plasticizers which are non-reactive with the isocyanate groups. Additionally a catalyst may be added to the second reactant. The scope of the present invention is intended to be defined by the appended claims and equivalents thereto.

What is claimed is:

1. A method of forming a chemical mechanical polishing pad comprising:
Providing a first reactant including an isocyanate functional polyurethane prepolymer;
Providing a second reactant including a diamine;
Impingement mixing the first reactant and the second reactant within an impingement mixer to begin formation of a polyurea polyurethane elastomer;
Injection molding the polyurea polyurethane elastomer that is formed from the mixed first and second reactants in a closed mold;
Demolding the polyurea polyurethane elastomer from the mold;
Curing the demolded polyurea polyurethane elastomer; and
Forming the polyurea polyurethane elastomer into chemical mechanical polishing pad dimensions.

2. The method of forming a chemical mechanical polishing pad according to claim 1 further including the step of dispersing an inert gas into at least one of the first and the second reactants.

3. The method of forming a chemical mechanical polishing pad according to claim 2 wherein the inert gas comprises one of CO₂, N₂, Ar, HFCs and combinations thereof.

4. The method of forming a chemical mechanical polishing pad according to claim 1 wherein the isocyanate functional polyurethane prepolymer has an isocyanate content of less that 15% by weight.

5. The method of forming a chemical mechanical polishing pad according to claim 1 wherein the isocyanate functional polyurethane prepolymer has an isocyanate content of 2% to 12% by weight.

6. The method of forming a chemical mechanical polishing pad according to claim 1 wherein the isocyanate functional polyurethane prepolymer has an isocyanate content of 4% to 10% by weight.

7. The method of forming a chemical mechanical polishing pad according to claim 1 wherein the impingement mixing of the first reactant and the second reactant within an impingement mixer to begin formation of a polyurea polyurethane elastomer has a ratio of the first reactant to the second reactant of 3:1 to 6:1 by weight.

8. The method of forming a chemical mechanical polishing pad according to claim 1 wherein the impingement mixing of the first reactant and the second reactant within an impingement mixer to begin formation of a polyurea polyurethane elastomer has a ratio of the first reactant to the second reactant of 4:1 to 5:1 by weight.

9. The method of forming a chemical mechanical polishing pad according to claim 1 wherein the second reactant is maintained above 100° C. before being supplied to the impingement mixer.

10. The method of forming a chemical mechanical polishing pad according to claim 1 wherein the second reactant is maintained 120° C. before being supplied to the impingement mixer.

11. The method of forming a chemical mechanical polishing pad according to claim 1 wherein the first reactant is maintained above 60° C. before being supplied to the impingement mixer.

12. The method of forming a chemical mechanical polishing pad according to claim 1 wherein the first reactant is maintained 80° C. before being supplied to the impingement mixer.

13. The method of forming a chemical mechanical polishing pad according to claim 1 wherein the injection molding of the polyurea polyurethane elastomer is performed above 80° C. and demolding occurs at greater than 5 minutes within the mold.

14. A method of forming a chemical mechanical polishing pad comprising:
Providing a first reactant including an isocyanate functional polyurethane prepolymer at a temperature above 60° C.;
Providing a second reactant including a diamine at a temperature above 100° C.;
Impingement mixing the first reactant and the second reactant within an impingement mixer to begin formation of a polyurea polyurethane elastomer, wherein the mixing is at a ratio of the first reactant to the second reactant of 3:1 to 6:1 by weight;
Casting the polyurea polyurethane elastomer that is formed from the mixed first and second reactants; and
Forming the polyurea polyurethane elastomer into chemical mechanical polishing pad dimensions.

15. The method of forming a chemical mechanical polishing pad according to claim 14 wherein the casting is open casting.

16. The method of forming a chemical mechanical polishing pad according to claim 14 wherein the casting is injection molding in a closed mold that is demolded after at least five minutes within the mold.

17. The method of forming a chemical mechanical polishing pad according to claim 14 further including the step of dispersing nitrogen into at least one of the first and the second reactants.

18. The method of forming a chemical mechanical polishing pad according to claim 17 wherein the diamine comprises an aromatic diamine having a molecular weight less than 400 g/mol and wherein the isocyanate functional polyurethane prepolymer is a reaction product of toluene di-isocyanate and polytetramethylene ether glycol having an isocyanate content of 4-10% by weight.

19. A method of forming a chemical mechanical polishing pad comprising:
Providing a first reactant including an isocyanate functional polyurethane prepolymer;
Providing a second reactant including a diamine;
Impingement mixing the first reactant and the second reactant within an impingement mixer to begin formation of a polyurea polyurethane elastomer;
Open casting the polyurea polyurethane elastomer that is formed from the mixed first and second reactants; and
Forming the polyurea polyurethane elastomer into chemical mechanical polishing pad dimensions.

20. The method of forming a chemical mechanical polishing pad according to claim 19 wherein the diamine comprises an aromatic diamine having a molecular weight less than 400 g/mol and wherein the isocyanate functional polyurethane prepolymer is a reaction product of toluene di-isocyanate and polytetramethylene ether glycol having an isocyanate content of 4-10% by weight.
